(19) United States
(12) Patent Application Publication
(10) Pub. No.: US 2006/0184923 A1
(43) Pub. Date: Aug. 17, 2006

(54) System, method, program, compiler and record carrier

(75) Inventors: Orlando Miguel Pires Dos Reis Moreira, Eindhoven (NL); Victor Martinus Gerardus Van Acht, Eindhoven (NL); Bernardo De Oliveira Kstrup Pereira, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninkllijke Philips Electronics, N.V., Eindhoven (NL)

(21) Appl. No.: 10/562,888

(22) PCT Filed: Jun. 30, 2004
(86) PCT No.: PCT/IB04/51055

§ 371 Date: Dec. 29, 2005

(30) Foreign Application Priority Data
Jul. 2, 2003 (EP) 03101975.5

(51) Int. Cl. G06F 9/45

(52) U.S. Cl. 717/140

(57) ABSTRACT

A processor system is described comprising at least a first and a second processor element (PEI, PE2). The first processor element (PEI) has a cluster request indicator (CR12) related to the second processor element and the second processor element (PE2) has a cluster request indicator (CR21) related to the first processor element. The processor elements have an instruction set enabling dynamic control of the indicators. The indicators (CR12, CR21) have a value range comprising at least a first value (positive indicator) indicating that the processor element requests to form a cluster with the related processor element, and a second value (negative indicator) indicating that the processor element does not request to form a cluster with the related processor element. The system further comprises a cluster control facility (CC12) which detects the value of the cluster request indicator and organizes the processor elements in clusters in accordance with the detected values. Two processor elements belong to the same cluster if they have positive indicators related to each other, or if there is a sequence of processor elements comprising those two processor elements wherein each pair of subsequent processor elements has positive indicators related to each other.

The invention relates to system comprising a plurality of processor elements.

The invention further relates to a method of operating a system comprising a plurality of processor elements.

The invention further relates to a program for a system comprising a plurality of processor elements.

The invention further relates to a compiler for generating the program.

The invention further relates to a record carrier comprising the program.

A Very Large Instruction Width processor (VLIW processor) is capable of executing many operations within one clock cycle. Generally, a compiler reduces program instructions to basic operations that the processor can perform simultaneously. The operations to be performed simultaneously are combined into a very long instruction word (VLIW). The instruction decoder of the VLIW processor issues the basic operations comprised in a VLIW to the respective processor element. Subsequently these processor elements execute the operations in the VLIW in parallel. This kind of parallelism, also referred to as instruction level parallelism (ILP) is particularly suitable for applications which involve a large amount of identical calculations as can be found e.g. in media processing. Other applications comprising more control oriented operations, e.g. for servo control purposes are not suitable for programming as a VLIW-program. However, often this kind of programs can be reduced to a plurality of program threads which can be executed independently of each other. The execution in parallel of such threads is also denoted as thread-level parallelism (TLP). A VLIW processor is however not suitable for executing a program using thread-level parallelism. Exploiting the latter type of parallelism requires that different processor data-path elements have an independent control flow, i.e. that they can access their own program in a sequence independent of each other, e.g. are capable of independently performing conditional branches. The data-path elements in a VLIW processor however operate in a lock step mode, i.e. they all execute a sequence of operations in the same order. The VLIW processor could therefore only execute one thread.

It is a purpose of the invention to provide a processor which is capable of using the same sub-set of data-path elements to exploit instruction level parallelism or task level parallelism or a combination thereof, dependent on the application.

According to the invention this purpose is achieved with the system claimed in claim 1. In the claimed system the processor elements have a programmable cluster request indicator. In response to the cluster request indicator the cluster control facility organizes the processor elements in clusters. Depending on the amount of instruction level parallelism and task level parallelism the number and size of these clusters can be adapted. Because the cluster request indicators are programmable the processor elements can themselves modify the value of this indicator as part of their instruction handling. The indicator can be programmed to be dependent on the occurrence of a certain condition.

The invention is in particular suitable to be applied in a processor system as described in the European Patent Application with filing number 02080600.6 filed 30.12.2002. In the earlier described processor system processor elements belonging to the same cluster operate in an instruction level parallel mode, while different clusters can execute different tasks in parallel. Processor elements in a cluster are said to run in lock-step mode. The present invention makes it possible to organize the clusters in a way dependent on the course of the execution of the instructions. More specifically, the present invention makes it possible to define and redefine clusters dynamically, in response to data or conditions that can only be evaluated during program execution.

It is noted that “Architecture and Implementation of a VLIW Supercomputer” by Colwell et all., in Proc. of Supercomputing '90, pp. 910-919 describe a VLIW processor, which can either be configured as two 14-wide processors, each independently controlled by a respective controller, or one 28-wide processor controlled by one controller. Said document, however, does not disclose the principle of a plurality of processor elements which by mutual arbitration on the basis of cluster request indicators can dynamically form clusters.

This principle enables the processor according to the invention to dynamically adapt its configuration to the most suitable form, depending on the task. In the case of a task having few possibilities for exploiting parallelism at instruction level, the processor can be configured as a relatively large number of small clusters (e.g. comprising only one, or a few, processor elements). This makes it possible to exploit parallelism at thread-level. If the task is very suitable for exploiting instruction level parallelism, as is often the case in media processing, the processor can be reconfigured to a small number of large clusters. The size of each cluster can be adapted to the requirements for processing speed. This makes it possible to have several threads of control flow in parallel, each having a number of functional units matching the ILP that can be exploited in that thread.

U.S. Pat. No. 6,266,760 describes a reconfigurable processor comprising a plurality of basic functional units, which can be configured to execute a particular function, e.g. as an ALU, an instruction store, a function store or a program counter. In this way the processor can be used in several ways, e.g. as a microprocessor, a VLIW processor or a MIMD processor. The document however does not disclose a processor comprising different processor elements each having a controller, where the processor elements can be configured in one or more clusters, and where processor elements within the same cluster operate under a common thread of control despite having their own controller, and where processors in mutually different clusters operate independently of each other, i.e. according to different threads of control.

U.S. Pat. No. 6,298,430 describes a user-configurable ultra-scalar multiprocessor which comprises a predetermined plurality of distributed configurable signal processors (DCSP) which are computational clusters that each have at least two sub microprocessors (SM) and one packet bus controller (PBC) that constitute a unit group. The DCSPs, the SM and the PBC are connected through local network buses. The PBC has communication buses that connect the PBC with each of the SMs. The communication buses of the PBC that connect the PBC with each SM have serial chains of one hardwired connection and one programmably-switchable connector. Each communication bus between the SMs has at least one hardwired connection and two programmably-switchable connectors. A plurality of SMs can be combined programmably into separate SM groups. All of a cluster's SMs can work either in an asynchronous mode, or in a synchronous mode, when clocking is done by a clock frequency from one SM in the cluster, which serves as the master. The known multi processor does not allow a configuration in clusters of an arbitrary size.

The present invention also relates to an information carrier comprising a set of VLIW instructions for a processor according to the invention. The VLIW instructions comprise a set of PE instruction to be executed by a respective processor element in the processor. At least one PE instructions is an instruction for controlling the configuration of said processor element in relation to other processor elements.

For example the processor system may be initialized as one task unit comprising all processor elements. One instruction may be used subsequently to decouple a single processor element from the initial task unit and to allow that processor element to operate independently.

The processor elements preferably each have their own instruction memory for example in the form of a cache. This facilitates independent operation of the processor elements. Alternatively, or in addition to their own local instruction memory, the processor elements may share a global memory.

In order to realize the purpose of the invention, the method of claim 4, the program of claim 5 and the compiler of claim 6 are additionally provided.

These and other aspects are described in more detail with reference to the drawing. Therein:

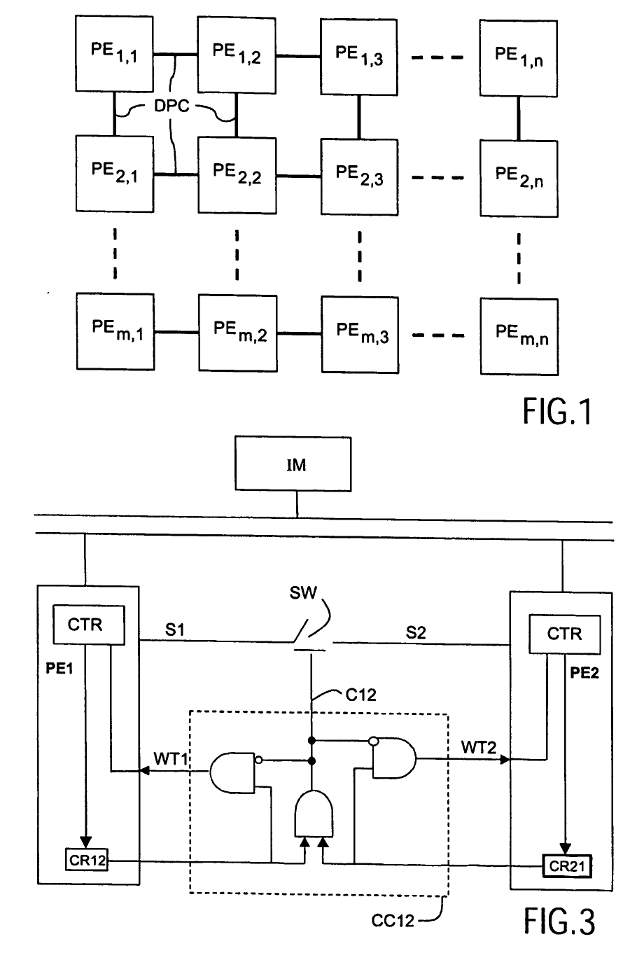

FIG. 1 schematically shows a processor system comprising a plurality of processor elements,

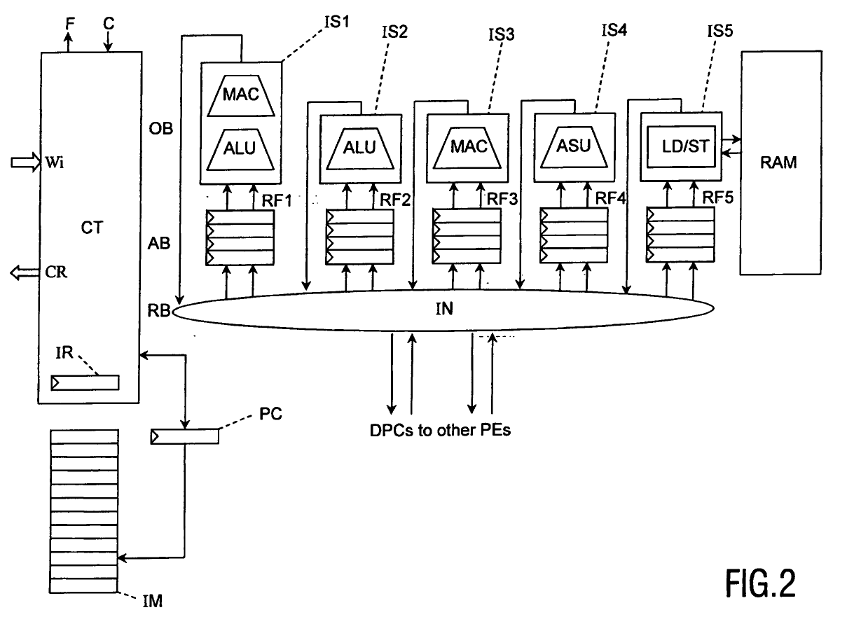

FIG. 2 shows in more detail an embodiment of a processor element for use in a processor system in the invention,

FIG. 3 shows an embodiment of a processor system according to the invention comprising a first and a second processor element,

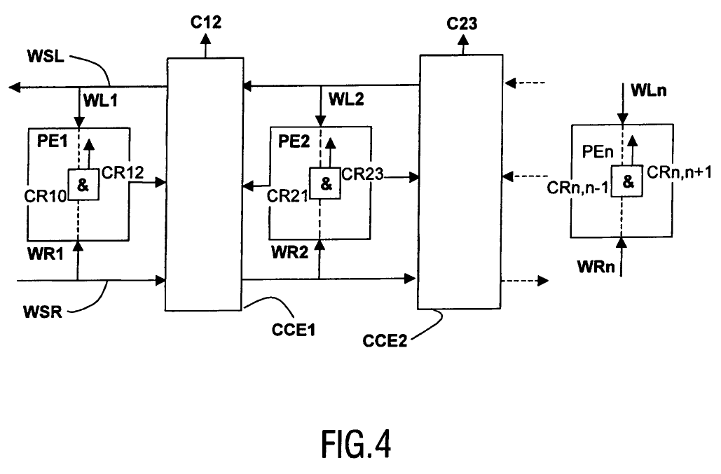

FIG. 4 shows an embodiment of the processor system according to the invention comprising an arbitrary number of processor elements PE1, . . . , PEn,

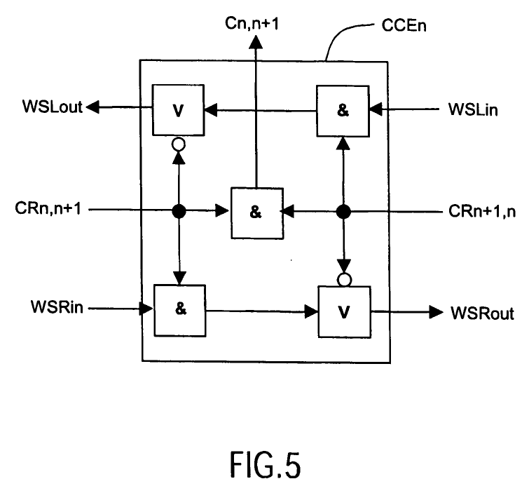

FIG. 5 shows in more detail a cluster control element CCEn for use in the processor system of FIG. 4,

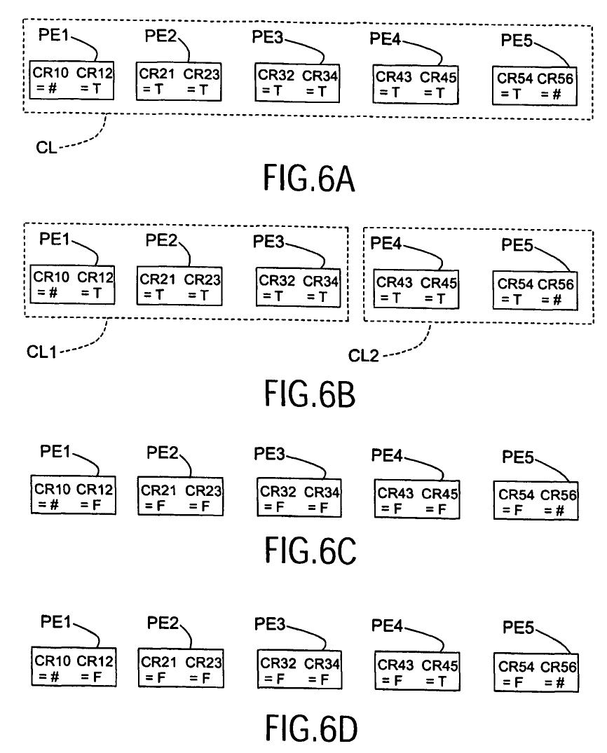

FIGS. 6A-D show examples of different configurations of a system as described with reference to FIGS. 4 and 5,

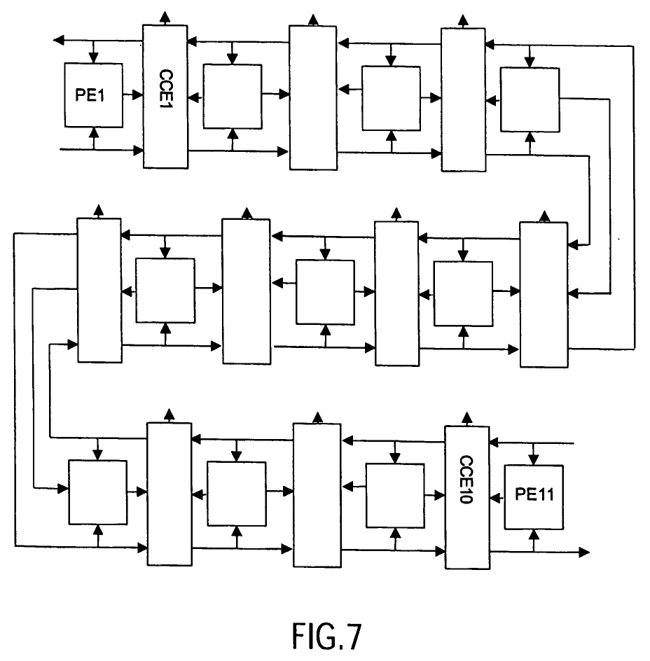

FIG. 7 shows the processor system of FIG. 4 arranged in a two-dimensional layout,

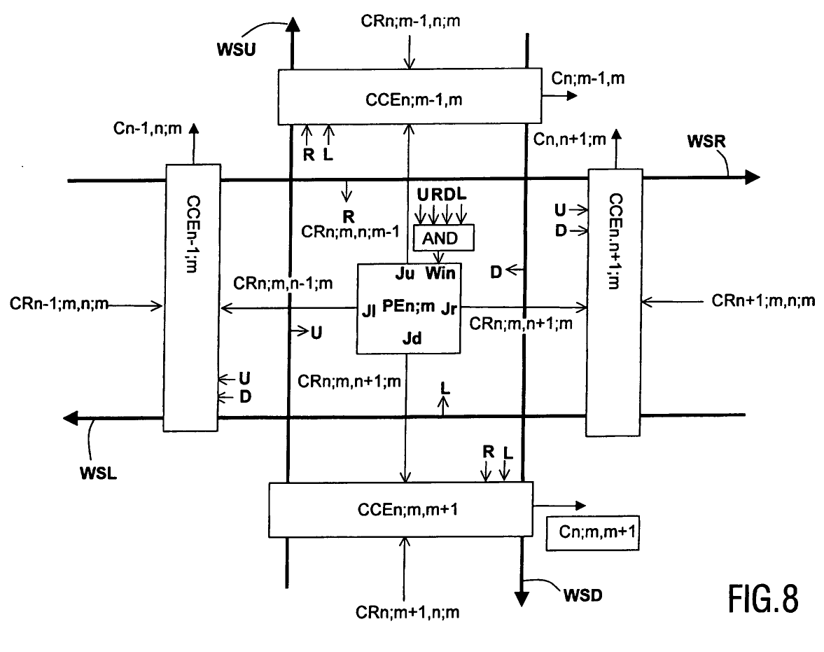

FIG. 8 shows an embodiment of the processor system according to the invention wherein the processor elements are capable of directly forming clusters with their 4 nearest neighbors,

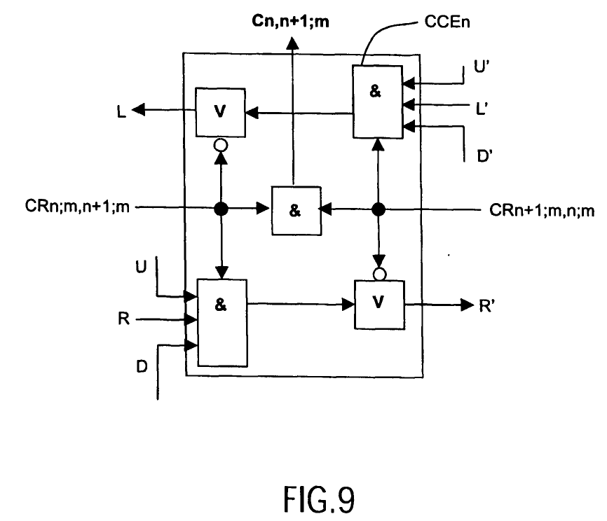

FIG. 9 shows an embodiment of a cluster control element for use in the processor system shown in FIG. 8,

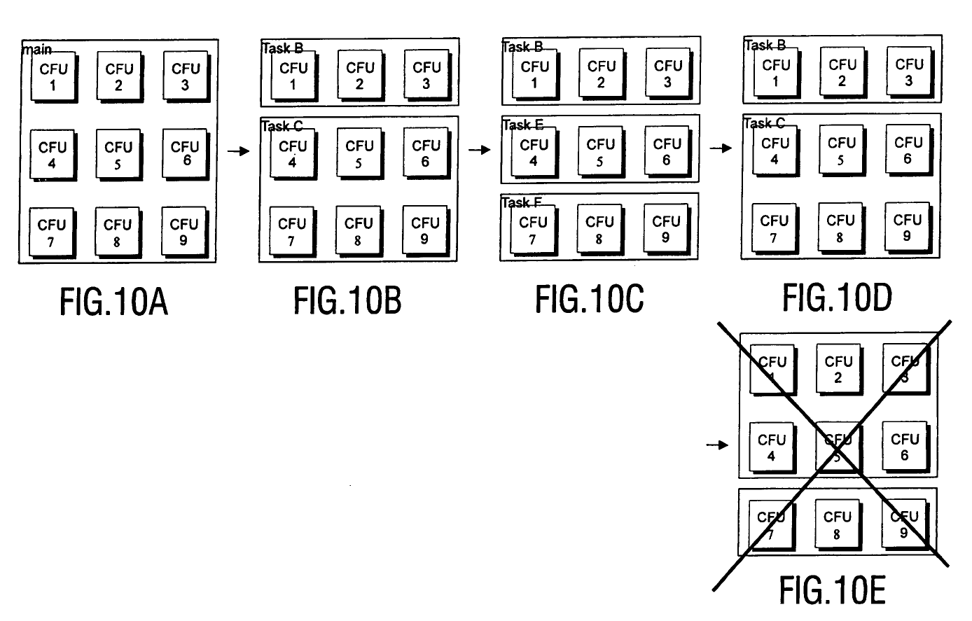

FIGS. 10A to 10E show examples of a dynamic reconfiguration of a processor system as shown in FIG. 8,

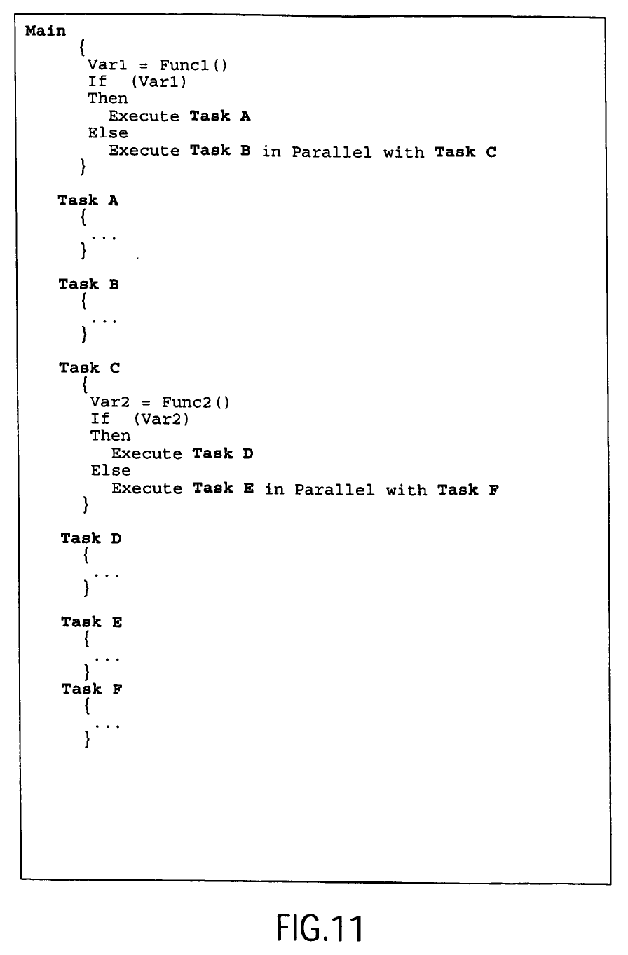

FIG. 11 shows an outline of a high level program suitable for a compiler for generating instructions for a processor system according to the invention.

FIG. 1 schematically shows a processor system which comprises a plurality of processor elements PE11, . . . PE1n; PE21 . . . PE2n; PEn1, . . . PEnn. The processor elements can exchange data via data path connections DPC. In the preferred embodiment shown in FIG. 1 the processor elements are arranged on a rectangular grid, and the data path connections provide for data exchange between neighboring processor elements. Non-neighboring processor elements may transfer data to other processor elements via a chain of mutually neighboring processor elements. Alternatively, or in addition, the processor system may comprise one or more global busses or point to point connections.

FIG. 2 shows an embodiment of a processor element in more detail. Each processor element comprises one or more functional units (FUs). In addition, the processor element comprises a local data memory. In the embodiment shown the FUs comprise two arithmetic logical units (ALU), a multiply accumulation unit (MAC), an application specific unit (ASU) and a load/store unit (LD/ST) connected to data memory (RAM). The functional units each have access to a private register file RF. The FUs are controlled by a controller CT which has access to an instruction memory IM. The controller communicates to the FUs, register files RF, and interconnect network IN via an opcode bus OB, an address bus AB, and a routing bus RB, respectively. A program counter determines the current instruction address. The controller has an input for receiving a cluster operation control signal C. This control signal C causes a guarded instruction, e.g. a conditional jump, to be carried out. The controller also has an output for providing an operation control signal F to other processor elements. This will be described in more detail in the sequel. The controller further has one or more inputs for receiving suspend signals Wi, which cause the processor element to suspend execution. Alternatively the controller may be coupled to a combination element which generates a single suspend signal from a plurality of suspend signals Wi. The controller further has outputs for providing cluster request indicators.

FIG. 3 shows an embodiment of a processor system according to the invention comprising a first and a second processor element PE1, PE2. For clarity most aspects already illustrated in FIGS. 1 and 2 are not repeated in this Figure. The first processor element PE1 has a programmable cluster request indicator CR12 related to the second processor element PE2 and the second processor element PE2 has a programmable cluster request indicator CR21 related to the first processor element PE1. The indicator has a value range comprising at least a first value (positive indicator) indicating that the processor element requests to form a cluster with the related processor element, and a second value (negative indicator) indicating that the processor element does not request to form a cluster with the related processor element.

During operation the controller CTR of a processor element PE1, PE2 reads a stream of instructions from the instruction memory. The instruction set of the processor elements comprises instructions which control the value of the cluster request indicator CR12, CR21. The skilled person can decide to control the value with one or more instructions. For example the instruction set of the processor elements may comprise a single instruction having parameters for indicating which configuration is desired. For example an instruction Configure (CU), wherein the parameters indicate the value to be assigned to the cluster control indicator. Otherwise the desired status could be indicated by separate instructions, e.g. an instruction Join to indicate a request to form a cluster with the other processor and an instruction Split to indicate the absence of a request.

The system further comprises a cluster control facility CC12 which detects the value of the cluster request indicators CR12, CR21 and organizes the processor elements PE1, PE2 in clusters in accordance with the detected values. The processor elements PE1, PE2 belong to the same cluster if they have positive indicators related to each other.

In the embodiment shown the cluster control facility CC12 comprises a dedicated logical circuit comprising standard logical components. The cluster control facility CC12 computes a cluster signal C12 which indicates whether the processor elements are clustered. The cluster signal is computed as follows: C12=CR12 AND CR21.

The cluster control facility in addition computes a first and a second wait signal WT1, WT2. This causes a particular processor element e.g. PE1 having a positive indicator to wait until the processor element PE2 to which that indicator is related also has a positive indicator related to that particular processor element. The signals WT1 and WT2 are calculated as follows:
WT1=CR12 AND NOT C12; WT2=CR21 AND NOT C12

That is, the wait signal is activated only if the respective processor element wants to form a cluster (signal CR active), but the cluster control facility CC12 indicates that a cluster is not (yet) to be formed (signal C12 not active).

The skilled person will be aware that several modifications are possible. Instead of using dedicated hardware for these calculations, a programmable general purpose facility could be used. Other gates can be used if definitions of the signals involved are inverted. The logical functions in the cluster control unit could be implemented by a lookup table, etc. The combination elements could for example be integrated in the processor elements.

The cluster signal C12 can be used to enable sharing of signals S1, S2 between the processor elements PE1, PE2. The signals S1, S2 may for example be used as a guard signal which, when active, causes the processor elements to carry out a conditional jump or another guarded operation. When the cluster signal C12 closes the switch the signals are coupled, i.e. each processor element can pull the signal up (or down) so that both processor elements PE1, PE2 do (or do not) carry out the guarded operation for example. In other words, when the cluster signal C12 closes the switch, both processor elements share the same guard (while either processor element remains free to evaluate that guard in the first place).

The sharing of a guard signal can enable different processor elements in a cluster to run in lock-step mode, in a single thread of control. This can be achieved by using the common guard signals with conditional jump operation (wherein the guard signal is the condition) and proper compile-time support, as described in the European Patent Application with filing number 02080600.6 filed 30 Dec. 2002.

The system may have the following operational modes, depending on the value of the cluster request indicators: A positive and a negative cluster request indicator are indicated by the terms ‘join’ and ‘split’ respectively.

| CR12 | CR21 | W1 | W2 | CL | System |
|---|---|---|---|---|---|
| join | join | continue | continue | cluster | ILP execution |
| join | split | suspend | continue | separate | processor 1 waits, |
| | | | | | processor 2 operates |
| split | join | continue | suspend | separate | processor 1 operates, |
| | | | | | processor 2 waits |
| split | split | continue | continue | separate | TLP execution |

The embodiment shown operates as follows. Each of the processor elements is capable of executing its own program. Hence, the system initially operates in task-level parallel mode. If only one instruction stream is available, one of the processor elements may be deactivated to save power. Instructions in the program indicate whether the processor element should execute its program in an instruction parallel way with the other processor element (join) or whether it should operate independently (split). In the absence of instructions the processor element may assume a default mode (e.g. split mode operation).

If both processor elements assume a split mode, the suspend signals are not active, and the configuration signal to the switch keeps the switch in the open state. This has the effect that both processor elements operate independently of each other, i.e. according to different threads of control. If both processor elements assume the join mode, the suspend signals are also inactive, but the configuration signal for the switch maintains the switch in the closed state. Hence the processor elements are coupled. One processor element may cause the other processor element to deviate from normal program flow and jump or execute a guarded instruction for example.

If one of the processor elements (for example PE1) assumes a split mode, and the other processor element (PE2) assumes a join mode the cluster control unit CCU provides an active suspend signal W2 to the processor element being in the join mode. This causes processor element PE2 having a positive cluster indicator to suspend processing until the other processor element PE1 has finished its current task and also indicates through a positive indicator that it is ready to form a cluster.

FIG. 4 shows an embodiment of the processor system comprising an arbitrary number of processor elements PE1, . . . , PEn. In the embodiment shown the processor elements are arranged in a chain. Each processor element has a first and a second programmable cluster request indicator. The second processor element PE2 for example has a first indicator CR23 and a second indicator CR21. This makes it possible to programmably control the number and size of the clusters. The first indicator CR23 indicates whether it requests to be part of a cluster with one or more other processor elements on one side of the chain (right side in the Figure) and the second indicator indicates whether it requests to be part of a cluster with one or more other processor elements on the other side of the chain (left side in the Figure).

In the embodiment shown in FIG. 4 the cluster control facility is in the form of a chain of cluster control elements CCE1, CCE2. In this embodiment the processor system can easily be extended by adding an extra cluster control element for each extra processor element. Hence the amount of hardware necessary for organizing the processor system into an arbitrary number of clusters comprising an arbitrary number of processor elements only grows linearly with the number of processor elements.

The cluster control elements CCE1, CCE2, . . . are coupled to each other by a first wait signal line WSL and a second wait signal line WSR. The wait signal lines carry a signal indicative of whether processor elements coupled to that line should suspend their activities. The first wait signal line carries its signal in a first direction, to the left in the drawing. The second wait signal carries its signal in a second direction, to the right in the drawing. The cluster control elements can modify these signals. As the cluster control elements form a bi-directional chain WCL, WCR, the cluster control logic not only maintains a processor element in the wait state if a neighboring processor element does not share the attempt to join, but also if there is another preceding processor element in the row which does not want to join yet with its right hand neighbor, while all the intermediate processor elements do want to join in both directions. In this way the processor elements destinated to form a cluster together each wait until all are ready.

An embodiment of a cluster control element CCEn is shown in more detail in FIG. 5. The cluster control element receives as input signals the input value WSLin of the first wait signal line WSL, the input value of the second wait signal line WSRin as well as the cluster request indicators CRn,n+1 and CRn+1,n. It provides as output signals a cluster signal Cn,n+1 as well as an output value WSLout for the first wait signal line WSL and an output value WSRout for the second wait signal line WSR.

The cluster signal Cn,n+1 has the value:
Cn,n+1=CRn,n+1 AND CRn+1,n.

The output signal for the first wait signal line has the value:

WSLout=NOT(CRn,n+1) OR (WSLin AND CRn+1,n). The output signal for the second wait signal line has the value:
WSRout=NOT(CRn+1,n) OR (WSRin AND CRn,n+1).

A processor element is forced in a wait state if either of the wait signal lines WSL or WSR to which it is connected signals this. In the embodiment shown a logical “0” value of the wait signal line signals that a wait state has to be assumed.

Examples of different configurations of a system as described with reference to FIGS. 4 and 5 are shown in FIGS. 6A-D. FIGS. 6A-D schematically shows different operational modes of a processor system comprising 5 processor elements PE1, . . . , PE5.

For clarity only the value of their cluster request indicators is shown:

In FIG. 6A all processor elements PE1, . . . , PE5 belong to the same cluster CL, because very two processor elements have positive indicators related to each other, or there is a sequence of processor elements comprising those two processor elements wherein each pair of subsequent processor elements have positive indicators related to each other. For example processor elements PE1 and PE2 have positive indicators CR12 and CR21 related to each other. For the processor element PE1 and PE5 there is a sequence of processor elements PE1, PE2, PE3, PE4, PE5 comprising those two processor elements PE1, PE5 wherein each pair of subsequent processor elements has positive indicators related to each other.

In the drawing the values of the cluster request indicators CR10 and CR56 are not relevant, as the processor element PE1 has no predecessor and the processor element PE5 has no successor. This is illustrated by a don't care “#”.

In FIG. 6B two clusters CL1 and CL2 are formed. The first cluster CL1 comprises processor elements PE1, PE2 and PE3. The second cluster CL2 comprises the processor elements PE4, PE5. For this reason all cluster request indicators except those at the boundary between the clusters CL1, CL2 are true.

In FIG. 6C all processor elements are independent. For this reason each of the cluster request indicators is false.

In FIG. 6D processor elements PE1, PE2, PE3 and PE5 operate independently. Processor element PE4 attempts to form a cluster with processor element PE5. It indicates this with positive indicator CR45. However, processor element PE5 has a negative indicator CR54. The cluster control facility (not shown here) detects this and issues a suspend signal towards processor element PE4, so that the latter waits until PE5 also has indicated that it is ready to form a cluster.

In the embodiment according to FIGS. 4, 5 and 6 the processor elements each have two cluster request indicators with which they can indicate in which direction they attempt to form a cluster. This is of practical value for use in a one-dimensional configuration. As shown in FIG. 7 this could likewise be applied in a two-dimensional arrangement of processor elements, as is schematically shown for a chain of processor elements and cluster control elements PE1, CCE1, . . . , CCE10, PE10.

However, preferably the cluster control architecture is closely related to the physical arrangement of the processor elements. I.e. in a two-dimensional arrangement the processor elements should be capable of directly forming clusters with their 4 nearest neighbors. An architecture enabling this is schematically shown in FIG. 8.

A processor element PEn;m is coupled to cluster control elements CCEn−1,n;m, CCEn,n+1;m, CCEn;m−1,m and CCEn;m,m+1 with neighbors PEn−1;m, PEn+1;m, PEn;m−1 and PEn;m+1. The cluster control elements enable the processor element to attempt to form clusters in any of four directions. The processor element PEn;m indicates this attempt with the cluster request signals CRn;m,n−1;m, CRn;m,n+1;m, CRn;m,n;m+1 and CRn;m,n;m−1.

The architecture comprises four wait signal lines WSL, WSR, WSU, WSD. The wait signal lines serve to suspend the operation of processor elements which attempt to form a cluster with processor elements which are not ready to join the cluster. The signal value of the signal lines WSL and WSR can be modified by the cluster control elements CCEn−1,n;m and CCEn,n+1;m. In a signal line segment of WSL and WSR extending between those control elements the signal values are indicated as L and R respectively. The signal value of the signal lines WSU and WSD can be modified by the cluster control elements CCEn;m−1,m and CCEn;m,m+1. In a signal line segment of WSU and WSD extending between the latter two control elements the signal values are indicated as U and D respectively. As long as any of the signal values R, L, U or D has a logical value “0” the processor element PEn;m is forced to suspend its activities.

The cluster control elements provide cluster signals Cn−1,n;m, Cn,n+1;m, Cn;m−1,m and Cn;m,m+1.

By way of example clustering is enabled in the directions up, left, down, right in the drawing. It will be clear to the skilled person however that this is a matter of choice. For example in a triangular grid the processor elements could have three join request signals indicative of a joining attempt in three directions, where the angles between the directions are 120°. Alternatively the processor elements could be arranged in a 3D pattern, and have 6 outputs, indicative of whether the processor attempts to join or not in 6 directions, positive and negative x-direction, positive and negative y-direction, positive and negative z-direction.

An embodiment of a cluster control element for the architecture of FIG. 8 is shown in FIG. 9. By way of example the cluster control element CCEn,n+1;m is described. This cluster control element provides the signal Cn,n+1;m which indicates a clustering between the processor elements PEn;m and PEn+1;m. It further provides the value L of the wait signal line WSL local to processor element PEn;m from the cluster request indicators CRn;m,n−1;m, CRn;m,n+1;m and the signal values L′, U′ and D′ of the wait signal lines WSL, WSU, WSD local to the processor element PEn+1;m. It further provides the value R ′ of the wait signal line WSR local to processor element PEn+1;m from the cluster request indicators CRn;m,n−1;m, CRn;m,n+1;m and the signal values L, U and D of the wait signal lines WSL, WSU, WSD local to the processor element PEn;m.

The signals Cn,n+1;m, L and R′ are calculated as follows:
Cn,n+1;m=CRn;m,n−1;m AND CRn;m,n+1;m
L=(CRn+1;m,n;m AND L′ AND U′ AND D′) OR NOT CRn;m,n+1;m
R′=(CRn;m,n+1;m AND R AND U AND D) OR NOT CRn+1;m,n;m

In an analogous way the cluster control element CCEn;m, m+1 calculates the signals
Cn;m,m+1=CRn;m,n;m+1 AND CRn;m+1,n;m
U=(CRn;m+1,n;m AND U″ AND L″ AND R″) OR NOT CRn;m,n;m+1
D′=(CRn;m,n;m+1 AND D AND L AND R) OR NOT CRn;m+1,n;m

Therein U″, L″ and R″ are the values of the wait signal lines WSU, WSL and WSR local to the processor element PEn;m+1.

The configuration of the processor can be controlled in software in a simple way. This can be done either by providing explicit instructions indicating which processor elements should join in clusters, or implicitly, leaving it up to the compiler to schedule the most favorable configuration.

To that end the processor elements should have a first instruction join which instructs a processor element to attempt to form a cluster with another processor element by providing a positive cluster request indicator.

The other processor elements with which a processor element can join are determined by the topology of the control network which enables the processor units to exchange cluster requests with each other. In principle the clustering allowed by the network is independent of the relative positions of the processor elements. However, for efficiency it is preferred that processor elements only join with their neighbors. Of course the neighbor can be joined to another neighbor so that the cluster can have any required size. In particular it is favorable if a processor element can be joined to its neighbors in two mutually transverse directions. This is very suitable for implementation of the processor system in a 2D plane and gives a great flexibility in defining clusters, while the complexity of the control circuitry for controlling the clustering is modest. Likewise it is conceivable to allow the processors to join with their neighbors in three mutually transverse directions, for example in an embodiment where the processor system is implemented in a multi-layered chip.

If there is more than one potential other processor element with which the processor element can attempt to form a cluster, then several first instructions can be provided, such as joinx+, joinx−, joinx indicating to the processor to join with another processor element in a positive direction of an x-axis, in a negative direction along said axis or in both directions. Analogously this could be extended for other directions, e.g. x, y and z-axis. The join instruction causes the processor element carrying it out to activate one or more join request signals.

Preferably a single join instruction is used, having as parameters the direction in which a processor should attempt to join with another processor.

Complementary to the join instruction is the second instruction split. The split instruction causes a cluster of processor elements to decompose into subclusters. Likewise there can be different second instructions to indicate the direction of a split, but preferably there is a single split instruction having parameters for indicating the direction into which the split should be carried out. The split instruction causes the processor element to deactivate one or more join request signals.

In an embodiment the split instruction reverses the effect of a join instruction. This implies that the split instruction may not form clusters which did not exist before. In this case one of the instructions does not need parameters but may simply undo the effect of the other instructions in the reverse order in which they were executed.

This is illustrated in FIGS. 10A-10E.

Suppose for example that the processor elements 1-9 initially form a single cluster as shown in FIG. 10A. As illustrated in FIG. 10B a first split instruction splits the cluster into a first subcluster with processor elements 1-3 for executing task B and a second one with processor elements 4-9 for executing task C. FIG. 10C shows how a second split instruction splits the second subcluster into two sub subclusters, with elements 4-6 and elements 7-9. These two sub subclusters execute tasks E and F respectively. In that case the first join instruction reunites the two sub subclusters in the subcluster of elements 4-9 as shown in FIG. 10D and the second join instruction reunites all elements in the single cluster shown in FIG. 10A. It would not be allowed to reconfigure the processor system straight from the configuration shown in FIG. 10C to the configuration shown in FIG. 10E.

Alternatively it is possible to have a single instruction which causes a processor element to alternately join with another processor element and split the connection with a processor.

Alternatively the processor element could have a single instruction, e.g.

Config(P1, P2, P3, P4) having a parameter corresponding to each other processor element with which it can potentially operate in a joined mode, with a first value of the parameter indicating that it should attempt to join the corresponding processor, and a second value of said parameter indicating that it should operate independently from the corresponding processor. The compiler or the programmer can schedule the program for the processor such that processor elements only attempt to join at the same time. For example if two processor elements first execute independent tasks A and B (TLP), of which task A is the shortest, and subsequently have to execute a common task in an ILP way, the moment that the processor executing task A tries to join can be delayed until the moment the other processor element tries to join by inserting NOP instructions. Instead of a sequence of NOP instructions the processor elements may carry out a NOP(N) instruction, wherein NOP(N) specifies the number of inactive cycles.

Preferably the control network generates a wait signal to keep a processor element requesting a join in a wait state until the other processor or cluster with which it wants to join also is ready to join. This strongly simplifies programming, in that it is no longer necessary to calculate the number of wait cycles. It further allows the processor elements to operate asynchronously, and to execute tasks which have a data dependent length.

FIG. 11 shows an example of how a programmer can instruct the compiler to generate object code including configuration instruction for the processor system according to the present invention. The description “Execute Task A” indicates to the compiler that the procedure specified for task A should be implemented in a single cluster comprising one or more processor elements. The description “Execute Task B in parallel with Task C” indicates to the compiler that Task B and Task C should be executed in separate clusters. Profiling allows the compiler to estimate the processing effort for each task. Depending on the estimated processing effort and the degree to which a task is executable in an ILP way, the compiler is enabled to assign a number of processor elements to the task units.

In the programming example shown the configuration of the processor is controlled dynamically. I.e. During execution of the main task the configuration of the processor is adapted. More in particular the chosen configuration is data dependent. For example the outcome of a function Func1( ) determines whether the processor system will execute task A, or task B and C in parallel. In translating this program fragment the compiler can assign the calculation of the function Func1( ) to one or more processor elements depending on the processing effort for said task and the degree to which it is executable in ILP. Subsequently one of the processor elements may deactivate its cluster request flag if it is determined that Var1 is FALSE. This results in the creation of two subclusters, one being assigned to task C. Depending on the outcome of a second function Func2( ) the processing of task C either continues as a task D on the same subcluster, or is carried out as two parallel threads which are executed at two sub subclusters of that cluster.

It is noted that the scope of protection of the invention is not restricted to the embodiments described herein. Neither is the scope of protection of the invention restricted by the reference numerals in the claims. The word ‘comprising’ does not exclude parts other than those mentioned in a claim. The word ‘a(n)’ preceding an element does not exclude a plurality of those elements. Means forming part of the invention may be implemented both in the form of dedicated hardware and in the form of a programmed general purpose processor. The invention resides in each new feature or combination of features.

1. A processor system comprising at least a first and a second processor element (PE1, PE2), the first processor element (PE1) having a cluster request indicator (CR12) related to the second processor element and the second processor element (PE2) having a cluster request indicator (CR21) related to the first processor element, the processor elements having an instruction set enabling dynamic control of the indicators, the indicators (CR12, CR21) having a value range comprising at least a first value (positive indicator) indicating that the processor element requests to form a cluster with the related processor element, and a second value (negative indicator) indicating that the processor element does not request to form a cluster with the related processor element, the system further comprising a cluster control facility (CC12) which detects the value of the cluster request indicators and organizes the processor elements in clusters in accordance with the detected values, two processor elements belonging to the same cluster if they have positive indicators related to each other, or if there is a sequence of processor elements comprising those two processor elements, wherein each pair of subsequent processor elements has positive indicators related to each other.

2. A processor system according to claim 1, wherein processor elements organized in a cluster operate under a common thread of control.

3. A processor system according to claim 1, wherein the cluster control facility (CC12) provides a suspend signal (WT1, WT2) to a processor element which attempts to form a cluster with other processor elements not yet ready to join said cluster.

4. A method for operating a system comprising at least a first and a second processor element, the method comprising programmably controlling a cluster request indicator of the first processor element related to the second processor element and programmably controlling a cluster request indicator of the second processor element related to the first processor element,
the indicator having a value range comprising at least a first value (positive indicator) indicating that the processor element requests to form a cluster with the related processor element, and a second value (negative indicator) indicating that the processor element does not request to form a cluster with the related processor element,
detecting the value of the cluster request indicators and organizing the processor elements in clusters in accordance with the detected values, two processor elements belonging to the same cluster if they have positive indicators related to each other, or if there is a sequence of processor elements comprising those two processor elements, wherein each pair of subsequent processor elements has positive indicators related to each other.

5. A program for a system comprising at least a first and a second processor element, the first processor element having a cluster request indicator related to the second processor element and the second processor element having a cluster request indicator related to the first processor element, the processor elements having an instruction set enabling dynamic control of the indicators, the indicator having a value range comprising at least a first value (positive indicator) indicating that the processor element requests to form a cluster with the related processor element, and a second value (negative indicator) indicating that the processor element does not request to form a cluster with the related processor element,
the system further comprising a cluster control facility which detects the value of the cluster request indicators and organizes the processor elements in clusters in accordance with the detected values, two processor elements belonging to the same cluster if they have positive indicators related to each other, or if there is a sequence of processor elements comprising those two processor elements wherein each pair of subsequent processor elements has positive indicators related to each other,
the program comprising at least a first instruction, which causes a change in the value of at least one of the cluster request indicators.

6. A compiler for generating a program according to claim 5.

7. A record carrier comprising a program according to claim 5.
